(19) United States
(12) Patent Application Publication
(10) Pub. No.: US 2011/0296621 A1
(43) Pub. Date: Dec. 8, 2011

(54) SUBJECT SUPPORT APPARATUS

(75) Inventor: Gilbert W. McKenna, Revere, MA (US)

(73) Assignee: ANALOGIC CORPORATION, Peabody, MA (US)

(21) Appl. No.: 13/128,519

(22) PCT Filed: Sep. 24, 2008
(86) PCT No.: PCT/US2008/077467

§ 371 Date: May 10, 2011

(51) Int. Cl. A47C 27/10; G05D 16/20

(52) U.S. Cl. 5/671; 5/690; 5/713; 700/301

(57) ABSTRACT

A subject support apparatus (100) includes a plurality of chambers (102) configured to hold a fluid under pressure and support a living being. At least one pressure transducer (108) determines a pressure of at least one of the chambers (108) and generates a signal indicative thereof. A controller (124) dynamically controls fluid entering and leaving the at least one chamber (102) based on the signal, thereby maintaining a pre-determined pressure range in the at least one chamber (102).

### TECHNICAL FIELD

The following generally relates to a subject support apparatus, and finds particular application to a subject support apparatus that selectively provides support to a subject supported by the support apparatus.

### BACKGROUND

A bed is a piece of furniture used by a human for sleep or rest and generally includes a mattress with springs, foam, pellets, water or air. A spring-based mattress may include a core of coiled springs surrounded by foam or batted cotton. Such a mattress tends to support only a few of the regions of a person lying on the mattress such as the buttocks, heals, elbows, shoulders and head. Foam and pellet based mattresses tend to conform to the shape of the person's body on the mattress and spreads more of the person's mass over the surface of the mattress. However, areas of the mattress that support the buttocks, heals, elbows, shoulders, head, etc. compress more than the other areas, leading these areas to bear more of the person's mass. Water and air beds also spread the person's mass over the surface of the mattress and generally are less susceptible to the above-noted load bearing associated with spring, foam and pellet mattresses. However, the skin on areas of the body supported by the liner of the mattress tends to be tensed.

Unfortunately, the above-noted mattress deficiencies may lead to the formation of high pressure points on the body at the locations where the body contacts the mattress. Such pressure points may result in suppression of blood flow, stress, increased weight bearing, increased temperature, and/or increased humidity at the areas of the body corresponding to the pressure points. This may lead to discomfort and interrupted sleep or rest as the person lying on the mattress changes position to relieve the discomfort. The consequences may be compounded in instances in which the person cannot readily re-position him/herself or be otherwise re-positioned to relieve the pressure, such as a person with limited re-positioning ability due to a doctor's order, treatment, lack of physical ability, etc. With such a person, a pressure point may lead to a decubitus ulcer, edema, delay in healing, worsening of a malcondition, and/or other undesirable effect.

### SUMMARY

Aspects of the application address the above matters, and others.

In one aspect, a subject support apparatus includes a plurality of chambers configured to hold a fluid under pressure and support a living being. At least one pressure transducer determines a pressure of at least one of the chambers and generates a signal indicative thereof. A controller dynamically controls fluid entering and leaving the at least one chamber based on the signal, thereby maintaining a pre-determined pressure range in the at least one chamber.

In another aspect, a method includes determining a real-time pressure of at least two chambers of a subject support apparatus supporting a subject and independently maintaining the pressure in each of the chambers within corresponding pre-determined pressure ranges for the chambers based on the real-time pressure.

In another aspect, a subject support includes a support structure with a plurality of air chambers configured to support a subject, a fluid source, and a closed loop control system that dynamically and individually controls that air pressure in two or more of the plurality of chambers based on individual pressures of the two or more chambers and a control program.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIGS. 1-3 illustrate example support apparatuses;

FIG. 4 illustrate a schematic block diagram showing fluid flow and control and data communication paths for the support apparatus;

FIGS. 5-10 illustrate example fluid chamber configurations;

FIG. 11 illustrates an example support apparatus;

FIG. 12 illustrates example air flow through the support apparatus; and

FIG. 13 illustrates an example support apparatus.

### DETAILED DESCRIPTION

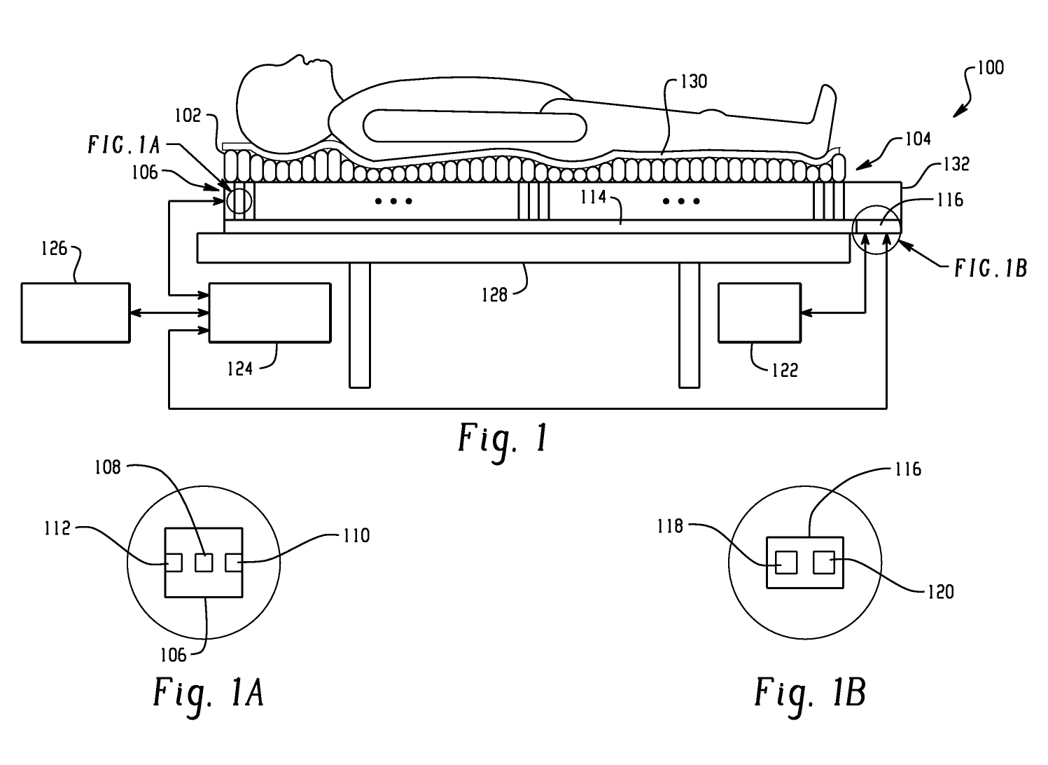

FIG. 1 illustrates a support apparatus 100 in connection with a human subject and a subject support 128. The support apparatus 100 includes a plurality of individual cells or chambers 102 configured to hold a fluid such as air, gas, water, gel, and/or the like under pressure. In the illustrated embodiment, the chambers 102 are affixed between a top layer 130 and substrate 132, and form a unitary support structure 104 with multiple chambers 102. The top layer 130 is flexible in that it can flex in response a change in a size of one or more of the chambers 102, and the top layer 130 and substrate 132 facilitate containing the chambers 102 in the unitary support structure 104. The support structure 104 is configured to support an object or subject such as an inanimate object, a human, an animal, or other object or subject.

At least one pressure regulator 106 is employed with at least one of the chambers 102. The pressure regulator 106 includes a transducer 108 that generates a signal indicative of a pressure in the at least one chamber 102. The pressure regulator 106 also includes an intake port 110 for receiving fluid into the chamber 102 and an exit port 112 for expelling fluid from the chamber 102. In another embodiment, at least one of the transducer 108, intake port 110, and the exit port 112 is part of a different component. In the illustrated embodiment, the regulators 106 are located between the support structure 104 and the bed 128 and within the substrate 132.

A manifold or plenum 114 receives fluid and routes the received fluid to the intake ports 110 of the pressure regulators 106. A valve 116 controls fluid entry into the plenum 114. The valve 116 includes a transducer 118 that generates a signal indicative of the pressure in the plenum 114 and an inlet 120 for receiving fluid into the plenum 114. Likewise, the plenum 114 and the valve 116 are located between the support structure 104 and the bed 128 and within the substrate 132.

A fluid source 122 supplies fluid for the plenum 114 to the inlet 120 of the valve 116. In the illustrated embodiment, the fluid source 122 includes a container such as a tank, a reservoir or the like, which is configured to hold a fluid under pressure. As shown, the fluid source 122 is affixed to the bed 128. In other embodiments, the fluid source 122 may be affixed to the support structure 104 or other structure. For example, in another embodiment the fluid source 122 inserts into a fluid source recess or receiving region in the substrate 132.

A controller (CTRL) 124 provides control data that effectuates operation of the regulators 106 and/or the valve 116. The controller 124 may include memory for storing executable control instructions, including default, operator programmed, and/or auto-generated control instructions, and one or more processors for executing the instructions. For explanatory purposes and clarity, FIG. 1 shows a communication/feedback path between the controller 124 and only one of the regulators 106. However, such a path may be included for one or more, including all, of the other regulators 106.

As described in greater detail below, the controller 124 can independently open and close one or more of the intake ports 110, the exit ports 112 and/or the inlet 120 based on a control instruction and one or more of signals generated by one or more of the transducers 108 and fed back to the controller 124. In one instance, the controller 124 employs the one or more feedback signals and control instruction to dynamically and automatically servo the fluid and, hence, the pressure in one or more of the chambers 102. Equilibrating or otherwise selectively setting the fluid pressure in the chambers 102 with the patient on the support structure 104 may mitigate higher pressure regions, for example, at the heals, buttocks, shoulders, head, elbows, etc., which may otherwise exist without such servo control of the fluid in the chambers 102.

An operator interface 126 allows an operator to set a value for a parameter used by the controller 124 to control the regulators 106 and valve 116. Such a parameter may include a pressure set point or range for one or more of the chambers 102, may identify a particular set of control instructions, or otherwise provide information to the controller 124. In addition, the operator interface 126 may present information about a parameter, a control instruction, at least one of the chambers 102, the plenum 114, at least one of the regulators 106 and/or the valve 116. Such presentation may be in a format perceivable by a human through sight, hearing, touch, etc., and/or by a non-human such as a robot, a computer, a monitoring station, and the like.

As noted above, the support apparatus 100 is shown in connection with the subject support 132. In the illustrated embodiment, the subject support 132 is a bed. In such an instance, the support apparatus 100 may be part of the mattress of the bed 128, part of a mattress cover for the bed 128, or part of a layer placed on top of the bed 128. In other embodiments, the support apparatus 100 may be used in connection with another structure such as a structure on which a subject may lie, sit, lean or stand on such as a transportation cart, a chair, a wall, a floor, etc. A particular support apparatus 100 can configured for general purpose or a particular application. For example, in one instance the same support apparatus 100 may be used in connection with the bed 128, a seat in an automobile, or other structure, while in another instance the support apparatus 100 is physically configured in accordance with a shape of the bed 128.

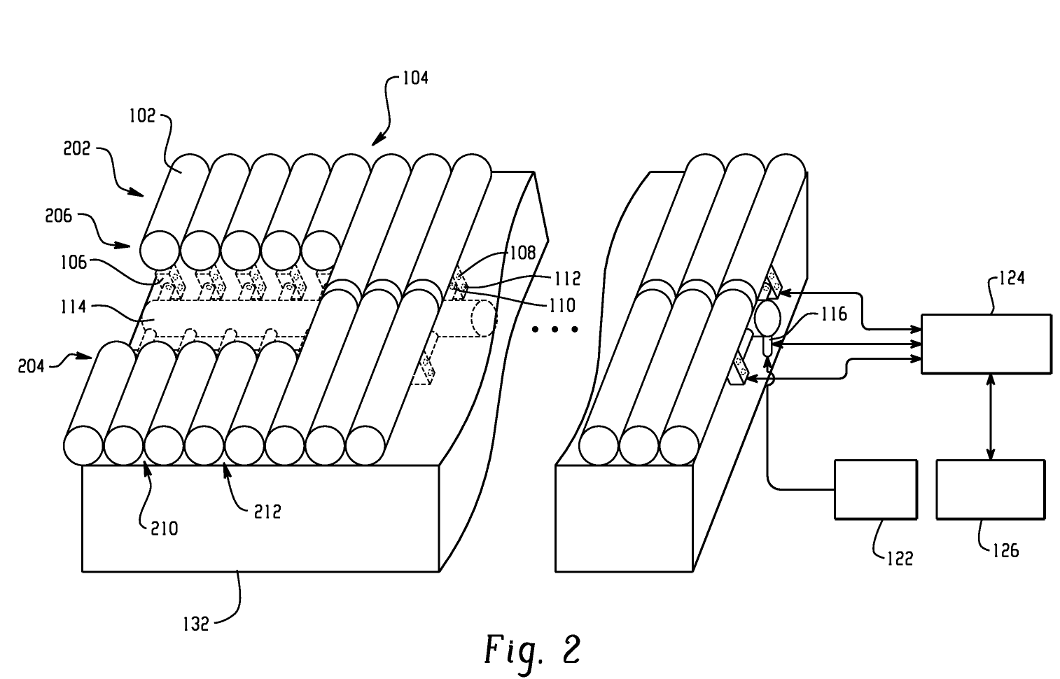

FIG. 2 illustrates an example embodiment of the supporting apparatus 100, showing a non-limiting chamber configuration. In this embodiment, a first region 202 of the support structure 104 includes a first plurality of the chambers 102, and a second region 204 of the support structure 104 includes a second plurality of the chambers 102. The first and second regions 202, 204 extend along a longitudinal axis of the support structure 104 and arranged so as to lie next to each other along a transverse direction. The chambers 102 are generally cylindrically shaped. In other embodiments, the chambers 102 are otherwise shaped, for example, cubicle, octagonal, or other volumetric shape. At 206, a portion of several of the chambers 102 is not shown in order to show structure located under the chambers 102.

The illustrated chambers 102 are affixed to the substrate 132. In one instance, the chambers 102 are affixed in a generally permanent manner in that the attachment is not made to be undone under ordinary usage. Such an attachment may be through a fastener such as an adhesive like glue, double-sided sticky tape, thread, or other attachment mechanism. In another instance, the chambers 102 are removably affixed to the substrate 132 via fasteners such as snaps, hook and loop fasteners, or the like, and can be variously installed and removed. The substrate 208 may also include one or more sides that extend from the surface of the common substrate 208 in a direction perpendicular to the surface of the substrate 208 from the side on which the chambers 102 reside. In this instance, the one or more sides may facilitate containing or holding the chambers 102 within the perimeter of the substrate 208.

The chambers 102 may additionally be attached together. For example, two neighboring chambers 102 may be attached to each other at region 210 where they touch or more generally at a region 212 between the chambers 102. Such an attachment may be generally permanent or releasable as described herein.

In operation, the operator interface 126 transmits a signal indicative of a control instruction to the controller 124. As noted herein, such an instruction may identify the control program, which may be a default, operator generated, or auto generated control program. The controller 124, based on the signal, controls the valve 116. This may include opening the inlet 120 of the valve 116, thereby filing the plenum 114 with fluid from the fluid source 122, maintaining the pressure in the plenum 114 within a particular pressure range using feedback from the transducer 118, and/or otherwise controlling the valve 116.

The controller 124, based on the signal, also controls one or more of the regulators 106. This may include opening corresponding ones of the intake ports 110 of the regulators 106, filing the corresponding chambers 102 with fluid from the plenum 114, maintaining the pressure in the chambers 102 within a particular pressure range using feedback from the transducer 108, and/or otherwise controlling the regulators 106.

An example of a non-limiting suitable pressure range for the chambers 102 includes a range from about 0.1 to about 5.0 psi (pounds per square inch) (˜0.7-34.5 kPa (kilo-pascal)) or other range suitable for supporting a patient on the support apparatus 100. For example, in one embodiment a chamber pressure in a range of about 0.5-2.0 psi is used to support a patient. Generally, the mass of the patient is spread over a plurality of the chambers 102, and the mass on any particular chamber 102 may be relatively small with respect to the total mass of the patient. A suitable pressure range for the plenum 114 includes a range suitable for supplying fluid to maintain the pressure range of the chambers 102.

The controller 124, using the signal from the operator interface, the signals fed back from the regulators 106 and valve 116, and/or other information, behave as a closed loop control system for maintaining a pressure in one or more of the chambers 102 and/or plenum 114. In one instance, this allows the controller 124 to servo the pressure in the chambers 102 based on real-time information about the pressure in the chambers 102.

For example, when the signal from the transducer 108 or 118 indicates a pressure in one or more of the chambers 102 or the plenum 116 is increasing or decreasing, the controller 124 accordingly controls the corresponding regulator 106 or the valve 116. As such, if a pressure in at least one of the chambers 102 increases, for example, when a subject lies, sits, rolls, or otherwise moves on the support apparatus 100, this increase is identified by the controller 124 via the feedback signal, and, if needed, the controller 124 controls the regulator 106 so as to open the exit port 112 to release fluid from the chamber 102, decreasing the pressure in the chamber 102, thereby maintaining the pressure in the chamber 102.

The control instruction can variously affect control of the chambers 102. For example, in one instance the control instruction causes the controller 124 to dynamically equilibrate the pressure in all or substantially all of the chambers 102 while an object or subject is on the support structure 104. This includes dynamically equilibrating the pressure when as a subject moves around on the support structure 104. The above may facilitate mitigating regions of higher pressure between subject and the support structure 104, for example, at the heals, head, buttocks, elbows, etc.

Additionally or alternatively, the control instruction causes the controller 124 to control the pressure in the chambers 102 based on a known, deterministic pattern. For example, the chambers 102 may be sequentially partially deflate and then re-inflate one or more times over a time interval. Alternatively, the deterministic pattern includes concurrently partially deflating and re-inflating more than two or more of the chambers 102, such as multiple neighboring or interleaved chambers 102 with one or more chambers 102 therebetween. This may provide a rhythmic and moving contraction or wave front along the subject. By way of example, this pattern may begin in a region by the legs of a human patient and move up towards the head of the patient. Such movement may promote blood flow from the feet to the heart, mitigate fluid retention in the feet, and/or otherwise facilitate patient care.

In another instance, the control instruction causes the controller 124 to control the pressure in the chambers 102 in a random manner. Such an instruction may randomly partially deflate and re-inflate one or more of the chambers 102 once, periodically (e.g., every 10 minutes), or aperiodically. This may add to the comfort level of the patient on the support structure 104.

In yet another instance, the control instruction causes the controller 124 to control the pressure in the chambers 102 to roll a patient in a controlled manner. The pressure can be modified as needed so that the patient can be rolled, elevated, or other wise moved around in the bed 128 by a practioner.

In still yet another instance, the control instruction causes the controller 124 to control the pressure in the chambers 102 based on a user generated program. For example, the pressure in one or more chambers 102 supporting a particular region of the patient, like a region corresponding to a portion of the patient that is healing, may be controlled in a different manner from other chambers 102. By way of example, the pressure in the chambers 102 around such a region may be maintained so as to promote healing, relieve pain, provide comfort, etc. for the patient.

It is also to be appreciated that an operator can use the operator interface 126 to override, adjust, terminate, and/or otherwise affect operation of the support apparatus 100. In one instance, this includes setting a pressure set point range, releasing, and/or increasing pressure in one or more particular chambers 102 and/or the plenum 114, and/or otherwise control the support apparatus 100. By way of non-limiting example, the operator interface 126 may present a virtual representation of the chambers 102, and an operator may select one or more of the chambers 102 from the virtual representation and input a signal that affects control of the selected one or more of the chambers 102.

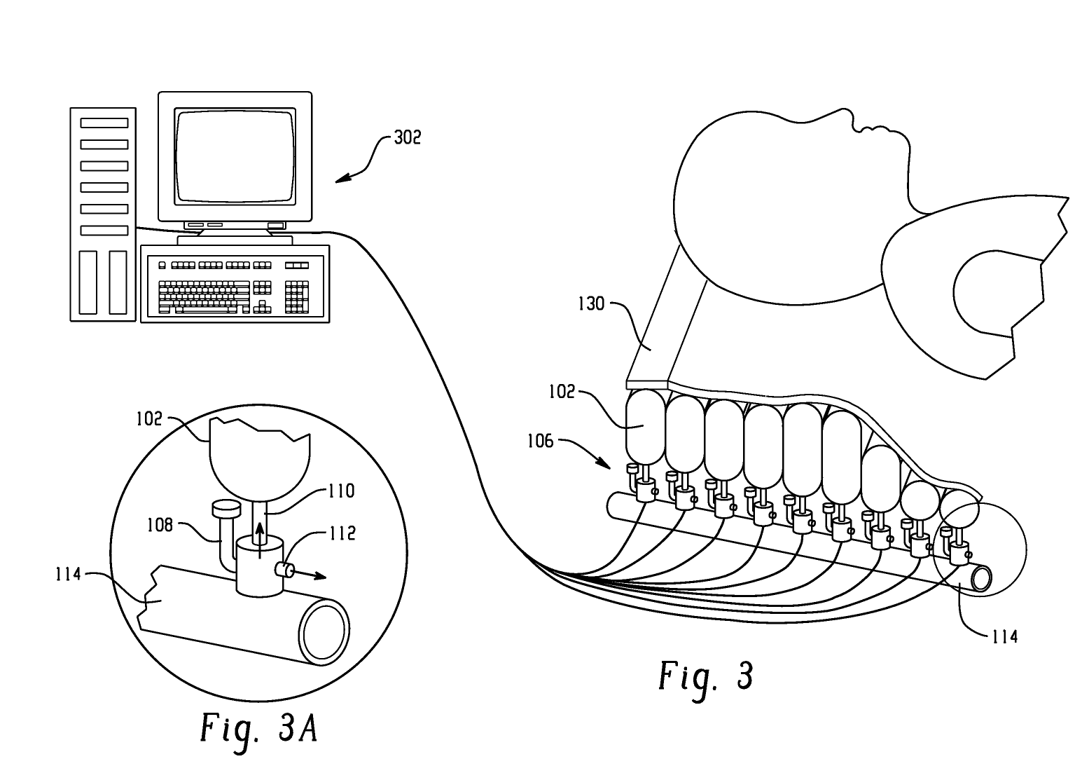

As shown in FIG. 3, a computing system such as a personal computer (PC) 302 can function as the controller 124 and user interface 126. Also shown in FIG. 3 is another suitable arrangement of the plenum 114 and the regulators 106 in which the plenum the regulators 106 are directly attached to the plenum 114, which is located below the regulators 106. Also shown in FIG. 3 are the data and/or control paths from the PC 302 to individual regulators 106.

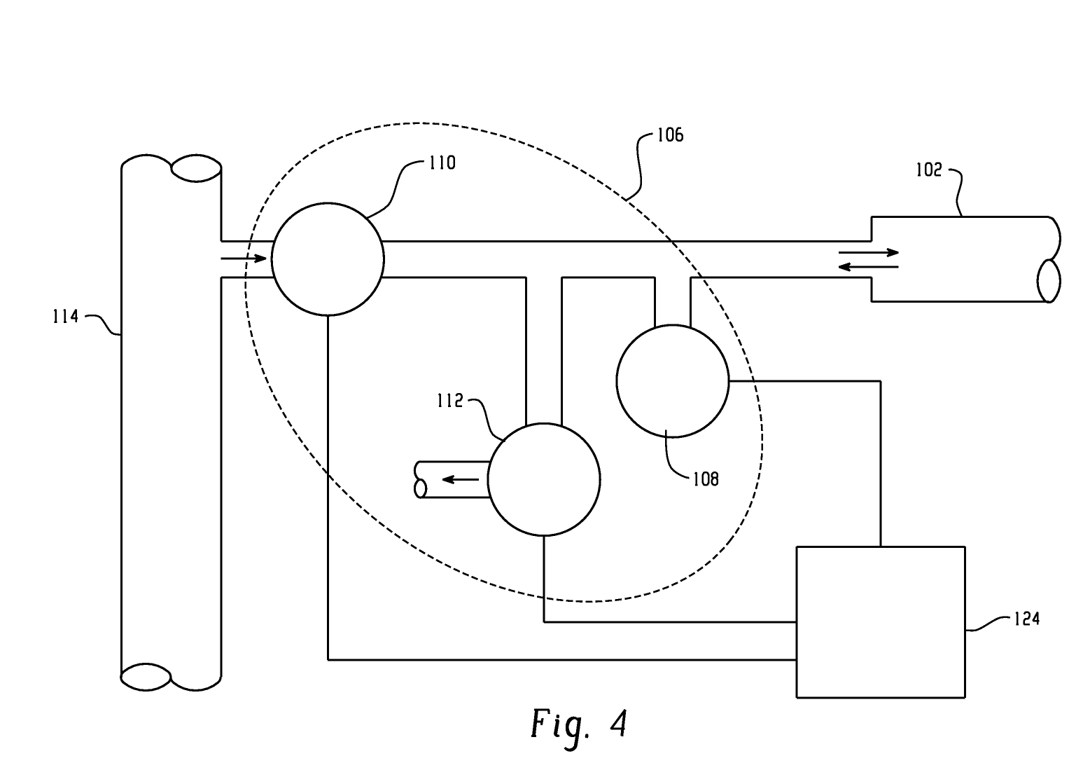

FIG. 4 illustrates a schematic block diagram showing fluid flow between the plenum 114, the intake port 110 of one of the regulators 106, one of the chambers 102, and the exit port 112 of the regulator 106, and communication paths between the controller 124 and the transducer 108 and intake and exit ports 110, 112 of the regulator 106.

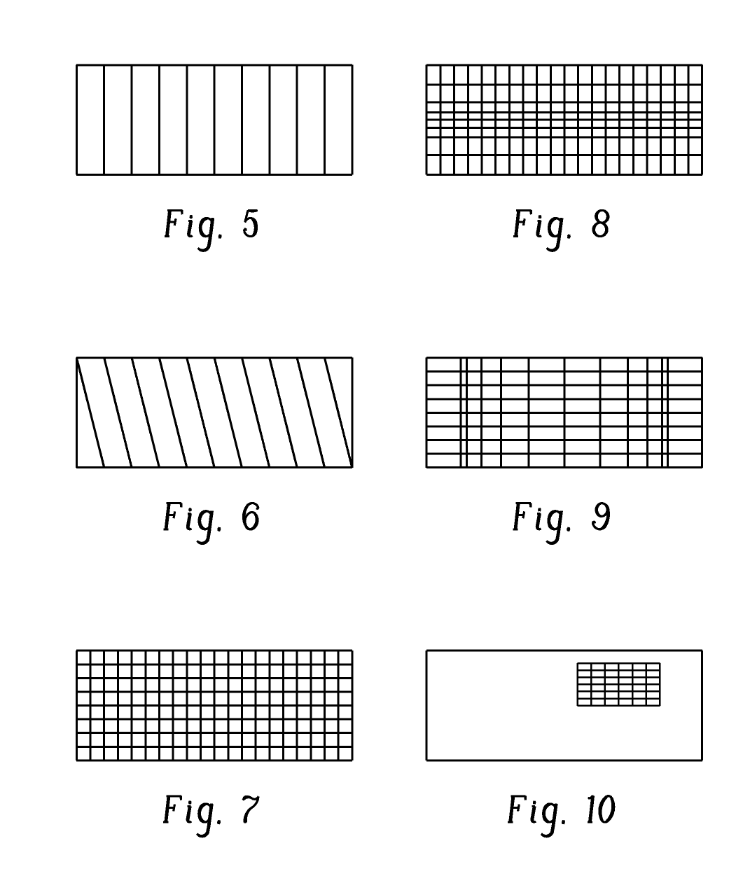

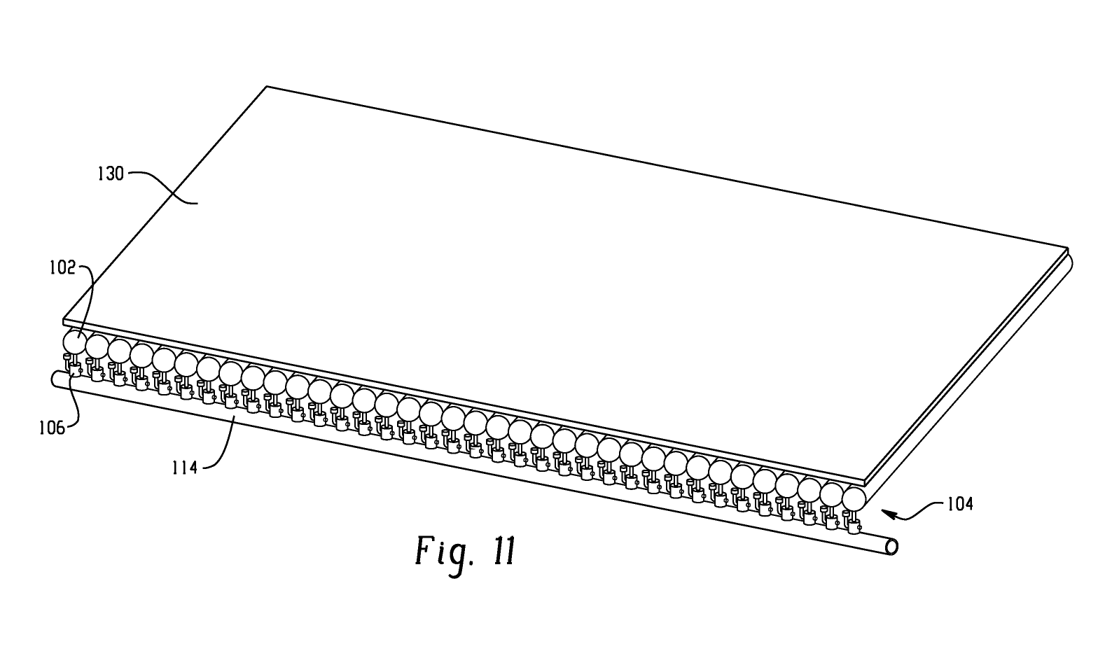

FIGS. 5-10 show various non-limiting alternate chamber arrangements for the support apparatus 100. In FIG. 5, the support apparatus 100 includes an array of chambers 102 aligned in parallel with each other and perpendicular to the longitudinal axis of the support structure 104. Alternatively, the array of chambers 102 may be aligned in parallel with each other and the longitudinal axis of the support structure 104. In FIG. 6, the chambers 102 are aligned diagonally with respect to the longitudinal axis 104. In FIG. 7, the support apparatus 100 includes a matrix of chambers. In FIGS. 8 and 9, the dimensions of the chambers vary. In FIG. 10, the support structure 104 includes a general area and sub-region within the area that includes a matrix of independently controlled chambers 102. Such an embodiment may be used to provide generally finer support in the sub-region relative to the support in the general area of the support structure 104. Although the chambers 102 are shown are being generally rectangular in shape, it is to be understood that other shapes are contemplated. Suitable other shapes include, but are not limited to, circular, triangular, pentagonal, hexagonal, octagonal, etc.

Variations are discussed.

In the illustrated embodiment, each of the chambers 102 has a corresponding regulator 106. In another embodiment, a single regulator 106 may be used to regulate fluid flow for two or more of the chambers 102.

In another embodiment, at least one of the regulators 106 includes a processor that selectively opens and closes a corresponding intake and exit port 110 and 112 based on the signal from a corresponding transducer 108. In this embodiment, the regulator 106 may be self-controlled and/or controlled by the controller 124.

Likewise, the valve 116 may include a processor that selectively opens and closes the intake port 120 based on the signal from the transducer 118.

In another embodiment, the regulators 106 and/or valve 116 include a wireless communications port and can transmit and receive information wirelessly and be controlled by a remote device such as a remote control, hand held computing device, central station, or the like.

In the illustrated embodiment, the regulators 106, the plenum 114 and/or the valve 116 are located in the substrate 132. In other embodiments, one or more of the regulators 106, the plenum 114 and/or the valve 116 may be otherwise located. For example, in FIG. 11 the regulators 106 and plenum 114 are located on the side of the supporting structure 104.

In another embodiment, the fluid source 122 alternatively includes a fluid mover such as a blower, a compressor, a pump, or the like, which produces fluid flow and transports fluid to the plenum inlet 120. With such an embodiment, the controller 124 and/or other control device may also control the fluid source 122.

In another embodiment, the apparatus 100 includes a closed fluid system in which fluid moves or is redistributed between chambers 102, the plenum 114, and a fluid repository, and is generally not expelled from the apparatus 100, when regulating the pressure in the chambers 102. However, it is to be understood that this does not preclude expelling fluid from the apparatus 100.

In another embodiment, air is transported to one or more regions between the chambers 102 and/or above the chambers 102. In one instance, the air is supplied by the chambers 102 and/or plenum 114. In this instance, one or more of the chambers 102 and/or the plenum 114 may include an air permeably material or includes one or more openings.

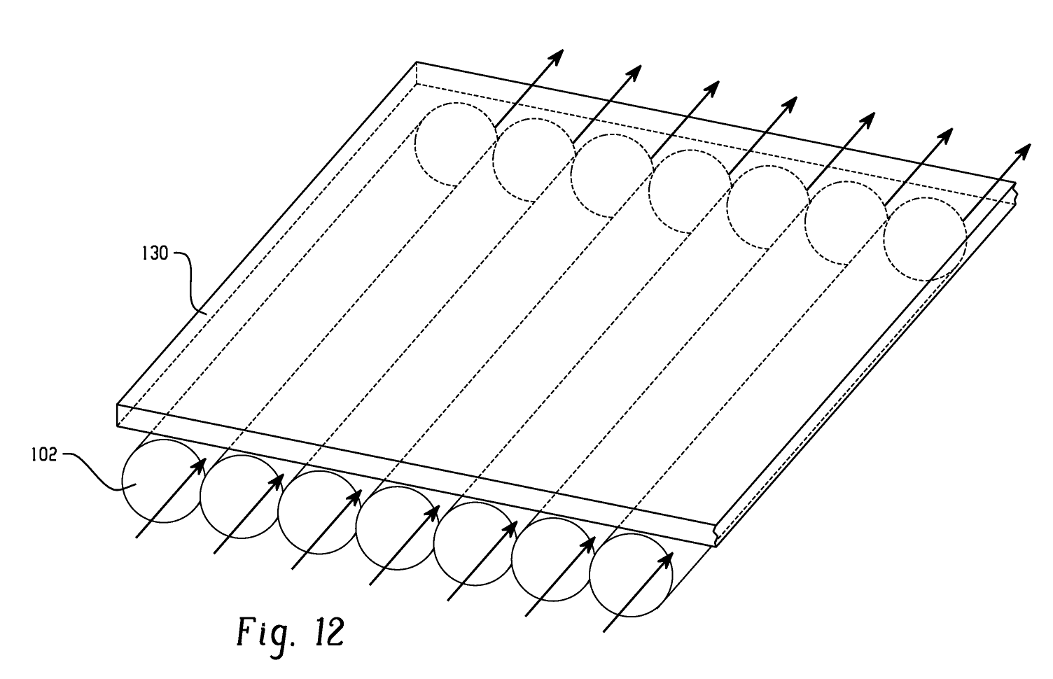

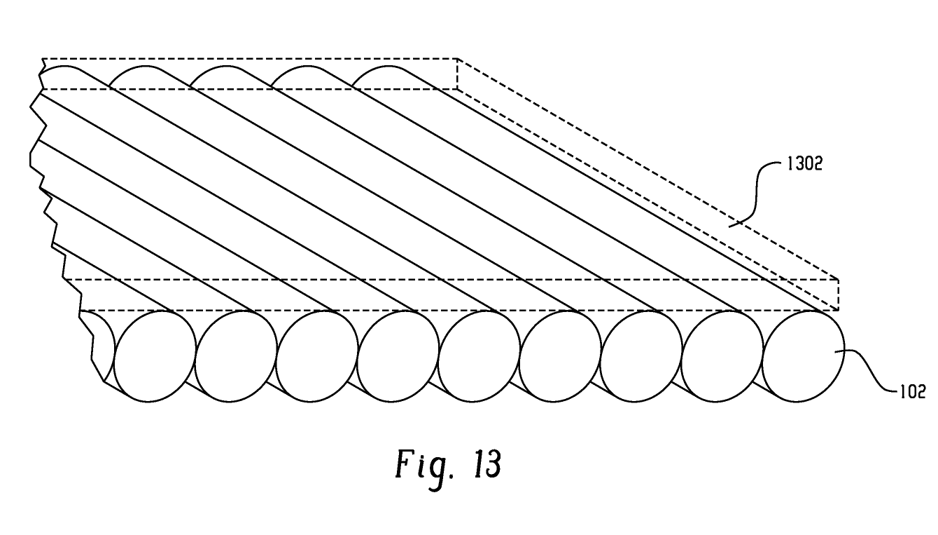

In another embodiment, the apparatus 100 may include one or more ducts that route the air from the plenum 114 or another air source to the one or more regions. FIG. 12 shows example air flow about the chambers 102. A dehumidifier may be used to control the humidity of the air supplied to the regions.

As shown in FIG. 13, a porous layer 1302 may be disposed over the chambers 102. In one instance, this layer may facilitate diffusing the air permeating through the chambers 102 over the surface of the support structure 104.

In another embodiment, the apparatus 100 includes a temperature regulator, including a heater and/or a cooler, which regulates the temperatures of the fluid entering the plenum 114. The controller 124 may control the temperature regulator based on a temperature set point, a temperature of the fluid in the plenum 114, a temperature of the fluid in one or more chambers 102, a temperature of a surface of the support structure 104 supporting the subject, and/or a temperature of the subject being supported.

In another embodiment, the controller 124 can derive information from the signals fed back to the controller 124. For example, the controller 124 can determine the patient's weight, activity level, location on the support apparatus 104, and/or other information. For example, for determining a subject's weight, the chambers 102 can be brought to a known pressure and then the pressure of the chambers 102 can be determined when the chambers 102 are supporting the subject, and the pressure difference therebetween can be used to determine the subject weight. Location can also be determined by this difference. The activity level of a subject can be determined based on a frequency of changes in the pressure of the chambers. The changes can also be used to determine the subject's new location.

The support apparatus 100 can be used to support living beings such as humans and animals as well as inanimate objects and other subjects and objects.

The application has been described with reference to various embodiments. Modifications and alterations will occur to others upon reading the application. It is intended that the invention be construed as including all such modifications and alterations, including insofar as they come within the scope of the appended claims and the equivalents thereof.

1. A subject support apparatus, comprising:
a plurality of individual chambers configured to hold a fluid and support a living being;
at least one pressure transducer that determines a pressure of at least one of the chambers and generates a signal indicative thereof; and
a controller that dynamically controls fluid entering and leaving the at least one chamber independent of the other chambers based on the signal, thereby maintaining a pre-determined pressure range in the at least one chamber.

2. The apparatus of claim 1, further including a regulator that controls fluid entry into the chamber and fluid expulsion from the chamber, wherein the controller controls the regulator based on the signal.

3. The apparatus of claim 2, wherein the regulator controls fluid entry and expulsion for a subset of the chambers, which includes at least two of the chambers.

4. The apparatus of any of claim 2, wherein the fluid is provided by a fluid source, including a pressurized fluid container or fluid mover.

5. The apparatus claims 1, further including:
a intake port that controls fluid entry into the chamber; and
an exit port that controls fluid expulsion from the chamber;
wherein the controller controls the intake port and the exit port based on the signal.

6. The apparatus of claim 5, wherein the controller controls the intake and exit ports based on a control program.

7. The apparatus of claim 6, further including an operator interface that provides a control signal that identifies the control program.

8. The apparatus of claims 1, wherein the controller independently maintains a first pressure in a first chamber and a second pressure in a second chamber.

9. The apparatus of claim 8, wherein the first and second pressures are different.

10. The apparatus of claim 8, wherein the first and second pressures are substantially the same.

11. The apparatus of any of claim 1, wherein the chambers include sets of elongate chambers disposed generally parallel to each and generally perpendicular to a longitudinal axis.

12. The apparatus of claim 11, wherein at least one set includes two or more chambers.

13. The apparatus of claim 1, wherein the controller controls fluid entering and leaving the chambers based on at least one of a deterministic, a random, or a user generated chamber inflation and deflation pattern.

14. The apparatus of claim 1, wherein the controller concurrently controls fluid entering and leaving a sub-set of the chambers.

15. The apparatus of claim 1, wherein the fluid is one of air or water.

16. A method, comprising:
determining a real-time pressure of at least two chambers of a subject support apparatus supporting a subject; and
independently and dynamically maintaining the pressure in each of the chambers within corresponding pre-determined pressure ranges for the chambers based on the real-time pressure.

17. The method of claim 16, wherein the chambers are permeable to air, and further including diffusing air permeating from the chambers between the chambers.

18. The method of claim 16, further including independently inflating and deflating the at least two chambers.

19. The method of claim 18, wherein the at least two chambers are inflated and deflated under computer control.

20. The method of claim 16, further including equilibrating the pressure in the at least two chambers.

21. The method of claim 16, further including determining a weight of the subject based on a pressure measurement with no weight on the chambers and a pressure measurement with the subject's weight on the chambers.

22. The method of claims 16, further including determining an activity level of the subject based on a frequency of change in the pressure.

23. The method of claim 16, further including determining a location of the subject based on change in the pressure.

24. The method of claim 16, further including selectively inflating and deflating the chambers to roll the subject on the chambers.

24. The method of claim 16, further including heating or cooling fluid entering the chambers.

25. A subject support, comprising:
a support structure, including a plurality of air chambers, configured to support a subject;
a fluid source; and
a closed loop control system that dynamically and individually controls the fluid pressure in two or more of the plurality of chambers based on individual pressures of the two or more chambers and a control program.

26. The subject support of claim 25, wherein the support structure is disposed on a structure on which the subject lays, sits, stands or leans against.

27. The subject support of claim 26, wherein the structure is a bed.

28. The subject support of claim 25, wherein the support structure is disposed on or part of a mattress.

29. The apparatus of claim 1, wherein the chambers are permeable to air, and air inside of the chamber permeates from the chambers over a surface of the apparatus.

30. The apparatus of claim 1, further comprising:
a closed fluid system, including the chambers, a plenum and a fluid repository, which provides the fluid entering and leaving the at least one chamber, wherein the fluid is redistributed between chambers, the plenum and the fluid repository when regulating the pressure in the chambers.
